(19) United States
(12) Patent Application Publication
(10) Pub. No.: US 2013/0339502 A1
(43) Pub. Date: Dec. 19, 2013

(54) TECHNIQUES TO MANAGE TRANSITIONS BETWEEN PRIVATE AND PUBLIC NETWORKS

(71) Applicants: Yves Pitsch, Mercer Island, WA (US); Rastan Boroujerdi, Bellevue, WA (US); Amit Sehgal, Redmond, WA (US); Santhosh Kopparapu, Redmond, WA (US)

(72) Inventors: Yves Pitsch, Mercer Island, WA (US); Rastan Boroujerdi, Bellevue, WA (US); Amit Sehgal, Redmond, WA (US); Santhosh Kopparapu, Redmond, WA (US)

(73) Assignee: MICROSOFT CORPORATION, Redmond, WA (US)

(21) Appl. No.: 13/524,533

(22) Filed: Jun. 15, 2012

(51) Int. Cl. G06F 15/16; H04W 8/00

(52) U.S. Cl. 709/223

(57) ABSTRACT

Techniques to manage transitions between private and public wireless networks for wireless devices are described. In one embodiment, for example, an apparatus may comprise a logic circuit and a memory unit. The apparatus may further include connection logic operative on the logic circuit to attempt a network connection by: retrieving a first access location value from the memory unit when attempting a network connection from the apparatus; retrieving a stored internal probe link from the memory unit when the access location value is internal; retrieving a stored external probe link from the memory unit when the access location value is external; attempting to connect to a network site referenced by the retrieved probe link; and connecting to a final location via the network site when the connection attempt to the network site is successful. Other embodiments are described and claimed.

### BACKGROUND

Many private wireless networks exist for use by wireless devices within the radius of the private wireless service. For example, many businesses provide a private corporate network for use by employees and authorized guests within the business premises. The same businesses may also provide an external network to allow employees or other authorized users to access the business's information from outside of the private network, e.g. from a public wireless network connection. At any given moment, however, a mobile application executing on a wireless device may need to connect to a server but may not know to which network to connect, or may have to transition from one network to the other, which may result in connection failures and a frustrating user experience. It is with respect to these and other considerations that the present improvements have been needed.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

Various embodiments are generally directed to techniques to manage transitions between private and public networks. Some embodiments are particularly directed to techniques to manage transitions between private and public wireless networks for wireless devices. In one embodiment, for example, an apparatus may comprise a logic circuit and a memory unit. The apparatus may further include connection logic operative on the logic circuit to attempt a network connection by: retrieving a first access location value from the memory unit when attempting a network connection from the apparatus; retrieving a stored internal probe link from the memory unit when the access location value is internal; retrieving a stored external probe link from the memory unit when the access location value is external; attempting to connect to a network site referenced by the retrieved probe link; and connecting to a final location via the network site when the connection attempt to the network site is successful. Other embodiments are described and claimed.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates an embodiment of a system to manage transitions between public and private wireless networks.

FIG. 2 illustrates an embodiment of an operating environment.

FIG. 3 illustrates an embodiment of a distributed system for the system of FIG. 1.

FIG. 4 illustrates an embodiment of a logic flow for managing a transition between a public and private network.

FIG. 5 illustrates an embodiment of a logic flow for discovering a network.

FIG. 6 illustrates an embodiment of a computing architecture.

FIG. 7 illustrates an embodiment of a communications architecture.

### DETAILED DESCRIPTION

Various embodiments are directed techniques for managing transitions between private and public wireless networks without losing connectivity. In various embodiments, a wireless device may use a discovery service to determine whether the wireless device is within the private network or not. Previously cached links, referred to as probe links, may be used to facilitate connections to a network end point. As a result, the embodiments can improve reliability of network connections, and improve a user experience for a user of a wireless device.

With general reference to notations and nomenclature used herein, the detailed descriptions which follow may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein which form part of one or more embodiments. Rather, the operations are machine operations. Useful machines for performing operations of various embodiments include general purpose digital computers or similar devices.

Various embodiments also relate to apparatus or systems for performing these operations. This apparatus may be specially constructed for the specific purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the method steps. The needed structure for a variety of these machines will appear from the description given.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives consistent with the claimed subject matter.

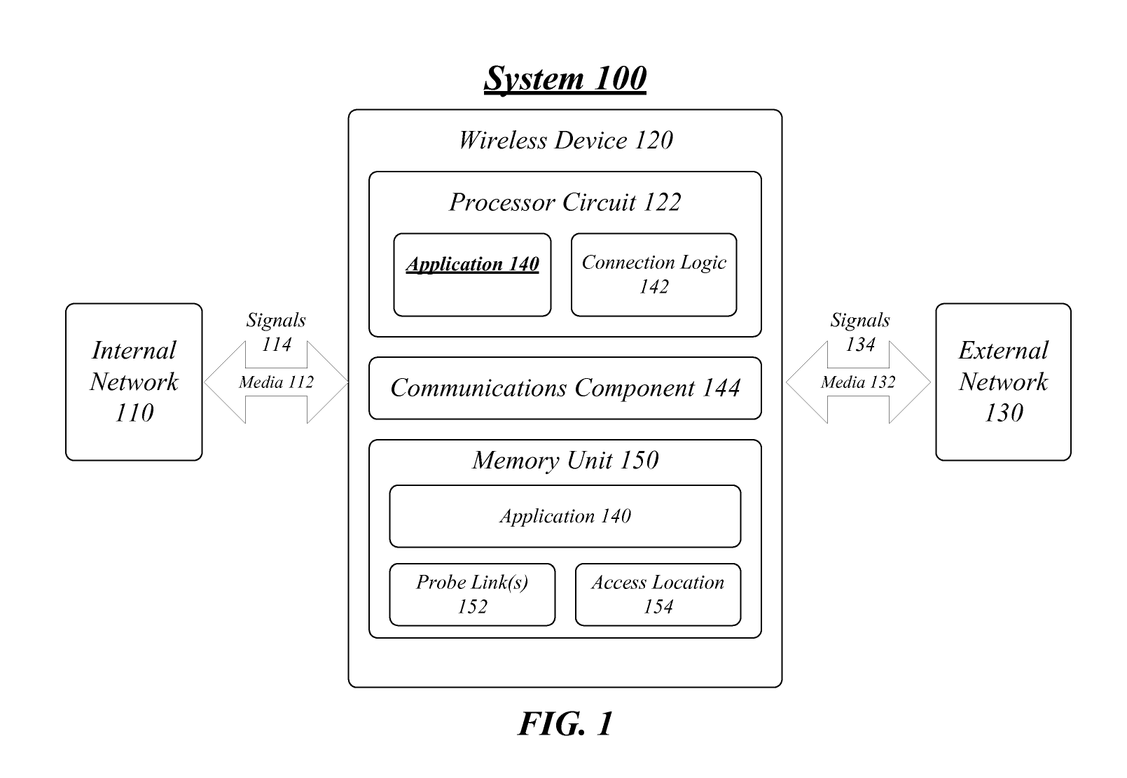

FIG. 1 illustrates a block diagram for a system 100. In one embodiment, the system 100 may comprise a computer-implemented system 100 having a wireless device 120, an internal network 110 and an external network 130. Although the system 100 shown in FIG. 1 has a limited number of elements in a certain topology, it may be appreciated that the system 100 may include more or fewer elements in alternate topologies as desired for a given implementation.

System 100 may include an internal network 110. Internal network 110 may include one or more servers that store data and provide services to electronic devices, such as wireless device 120, that communicate with them. Internal network 110 may be a network configuration arranged to provide network access, to the data and servers, to a limited number of authorized users. Internal network 110 may be a private network, such as a corporate internal network, provided by a private entity. For the purposes of discussion, a private entity may be any individual or organization that owns and/or maintains the internal network 110, configures access to the internal network 110, provides support services for internal network 110, and so forth. Examples of private entities may include, for example, a for-profit business, a non-profit organization, a government entity, an educational institution, a healthcare providing organization, and so forth.

Internal network 110 may provide, at least, wireless access, and may also provide wired access, to appropriately configured devices. In particular, internal network 110 may provide wireless access to private data, applications and services to authorized users using wireless devices within a certain physical proximity to wireless connection points within the premises of the private entity.

The system 100 may comprise a wireless device 120. Wireless device 120 may be any electronic device capable of receiving, processing, and sending information wirelessly for the system 100. Wireless device 120 may be generally arranged to connect to a network wirelessly to communicate with a device also connected to the network, such as other wireless devices, servers, routers, other computing devices and so forth. Examples of a wireless device 120 may include, without limitation, an ultra-mobile device, a mobile device, a personal digital assistant (PDA), a mobile computing device, a smart phone, a telephone, a digital telephone, a cellular telephone, ebook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, television, digital television, set top box, wireless access point, base station, subscriber station, mobile subscriber center, radio network controller, router, hub, gateway, bridge, switch, machine, or combination thereof. The embodiments are not limited in this context.

Wireless device 120 may comprise a processor circuit 122. Processor circuit 122 may be generally arranged to execute program logic, e.g. software instructions, to perform various functions to operate wireless device 120 and to provide functionality to a user. Processor circuit 122 may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Processor circuit 122 may, for example, execute application 140. Application 140 may be any application that may be used by a user of the device. Examples of applications 140 may include, without limitation, an e-mail application, a contact management application, a web browsing application, a game, a multi-media player application, a word processing application, a messaging application, a social networking application, and so forth. Of interest for the following discussion are applications 140 that use a network connection, for example, to retrieve e-mail messages, synchronize calendars, send and receive text messages, and so forth. If wireless device 120 had not previously been using a network connection, launching application 140 may cause wireless device 120 to seek a network connection.

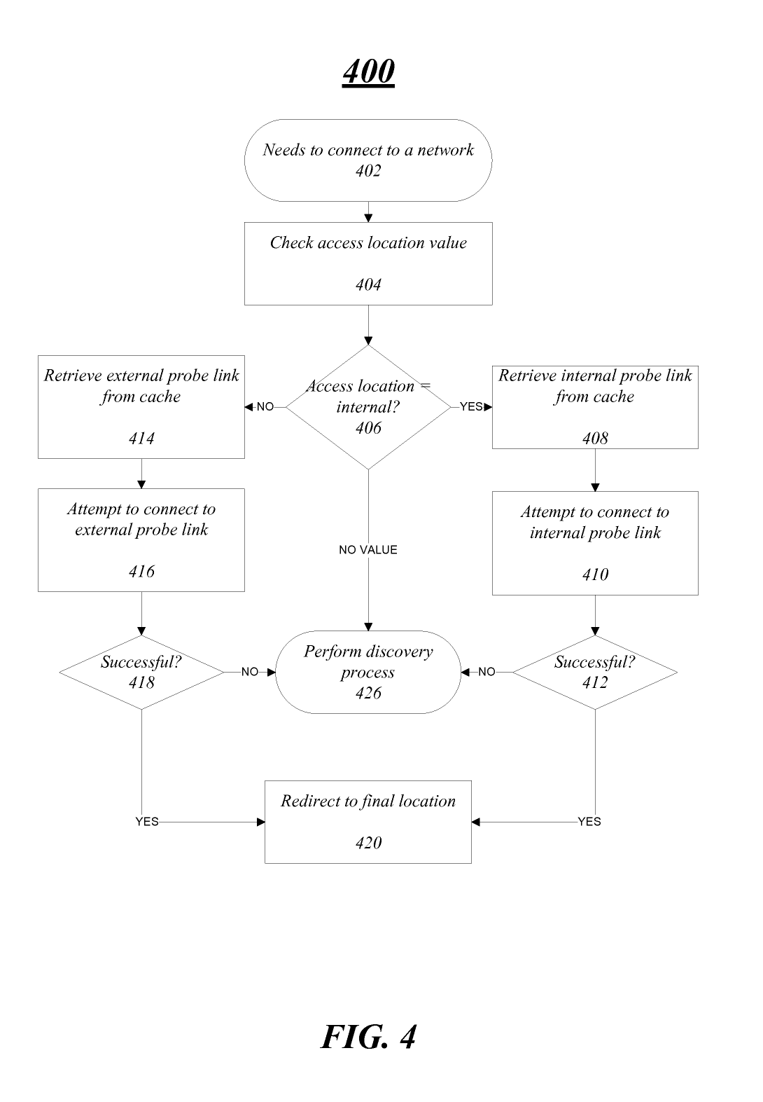

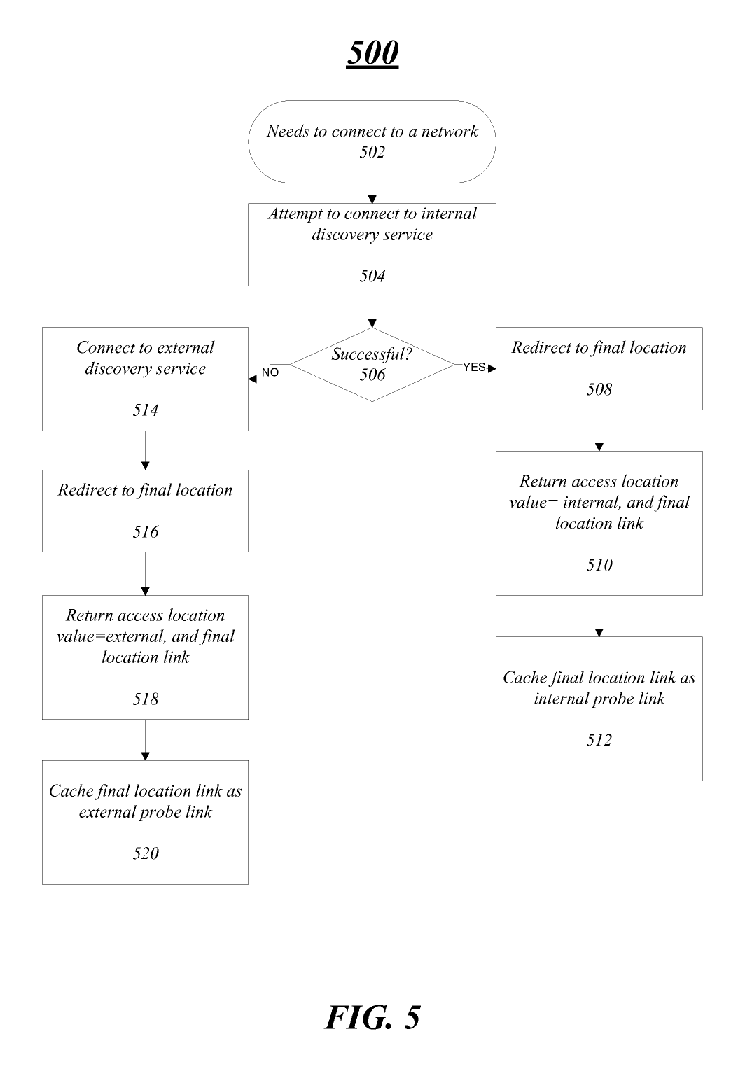

Wireless device 120 may further comprise connection logic 142. Connection logic 142 may execute on processor circuit 122 or on communications component 144 to manage transitions between private and public networks for wireless device 120, as will be described further below with respect to FIGS. 4 and 5.

Wireless device 120 may further comprise a communications component 144. The communications component 144 may implement any well-known communications techniques and protocols, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The communications component 144 may include various types of standard communication elements, such as one or more communications interfaces, network interfaces, network interface cards (NIC), radios, wireless transmitters/receivers (transceivers), wired and/or wireless communication media, physical connectors, and so forth. By way of example, and not limitation, communication media 112, 132 include wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media. Wireless device 120 may communicate with internal network 110 and external network 130 over a communications media 112, 132, respectively, using communications signals 114, 134, respectively, via the communications component 144.

Wireless device 120 may comprise a memory unit 150. Memory unit 150 may include volatile and/or non-volatile computer-readable storage media that store software instructions and data for execution and use by processor circuit 122. For example, memory unit 150 may store the executable instructions that make up application 140. Memory unit 150 may also store data, such as probe link(s) 152 and an access location 154 value.

A probe link 152 may be a reference, network address, uniform resource locator (URL) or the like, that links to an end point of a previously successful network connection. Access location 154 may be a variable or flag that has a value that indicates an internal location, an external location, or an undetermined location.

System 100 may include an external network 130. External network 130 may include some or all of the same servers within internal network 110. The servers may have separate access points for internal connections and external connections, depending on where a connection request is coming from. External network 130 may be accessible from public networks, such as the Internet, and networks provided by network service providers, such as cellular telephone networks, public Wi-Fi networks, or a 3G or 4G network.

In various embodiments, users of a wireless device 120 who would be able to access internal network 110, e.g. an employee or other authorized user, may also be able to access at least some internal data and services in internal network 110 from external network 130. Some authentication and/or encryption operations may be used to prevent unauthorized access to private data in those scenarios.

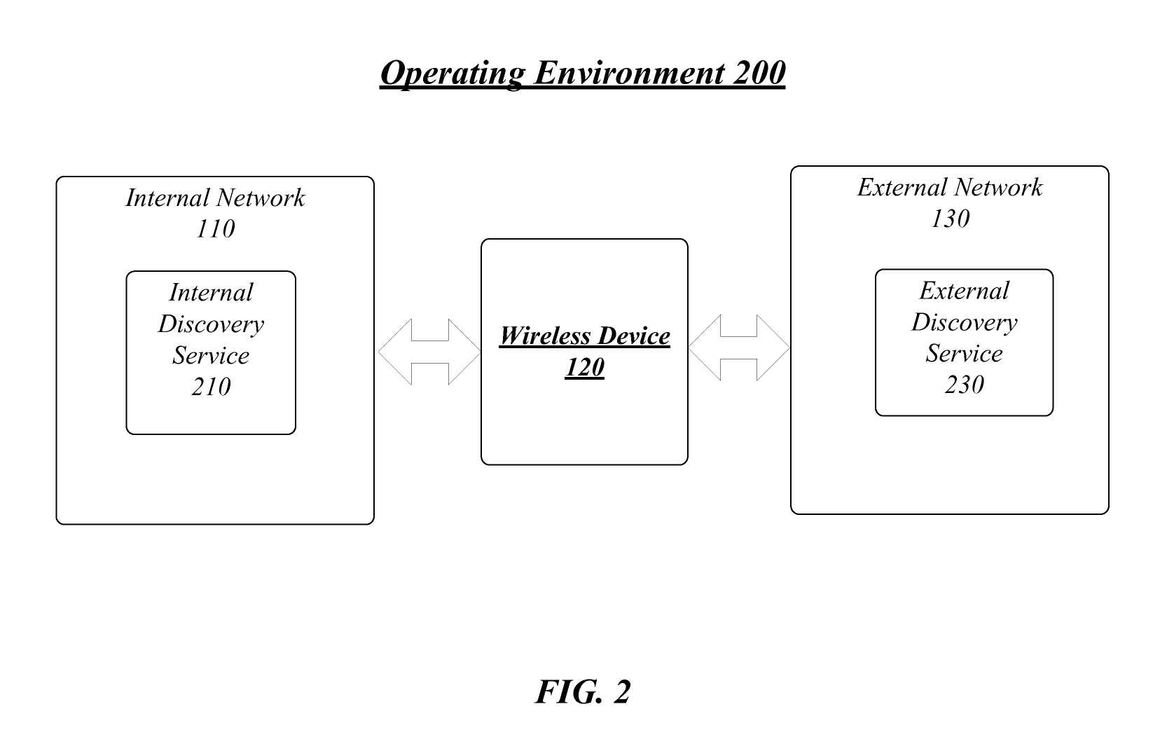

FIG. 2 illustrates an embodiment of an operational environment 200 for the system 100. As shown in FIG. 2, internal network 110 may include an internal discovery service 210. Internal discovery service 210 may provide a link to a service that can respond to a connection attempt with an access location value. Internal discovery service 210 may be accessed by a link, for example, a URL of the form “lyncdiscoverinternal.domain.com.”

Suppose that a wireless device 120 attempts to connect to the service using the link to internal discovery service 210. When the wireless device is within the internal network, the connection may succeed. Internal discovery service 210 may return an access location 154 value of “internal”. When the wireless device 120 is outside of the internal network, the connection will fail.

Assuming a successful internal connection, connection logic 142 may then proceed to redirect the connection to the desired network location. The redirection process may be used to handle distributed network topologies, and may include one or more hops to different URLs before ending at an end point, e.g. the final destination within the internal network. This final URL may be cached as an internal probe link 152.

As shown in FIG. 2, external network 130 may include an external discovery service 230. External discovery service 230 may provide a link to a service that is accessible outside of the internal network 110. The service may respond to a connection attempt with an access location value. External discovery service 230 may be accessed by a link, for example, a URL of the form “lyncdiscover.domain.com.”

Suppose that a wireless device 120 attempts to connect to the service using the link to external discovery service 230. When the wireless device is outside of the internal network, the connection may succeed. External discovery service 230 may return an access location 154 value of “external”. When the wireless device 120 is inside of the internal network, the connection will typically fail. However, in some situations the connection could succeed as well. Hence, to avoid any ambiguity the internal URL is probed first and only when that fails is the external URL probed.

Assuming a successful external connection, connection logic 142 may then proceed to redirect the connection to the desired network location. The redirection process may include one or more hops to different URLs before ending at an end point, e.g. the final destination within the external network. This final URL may be cached as an external probe link 152.

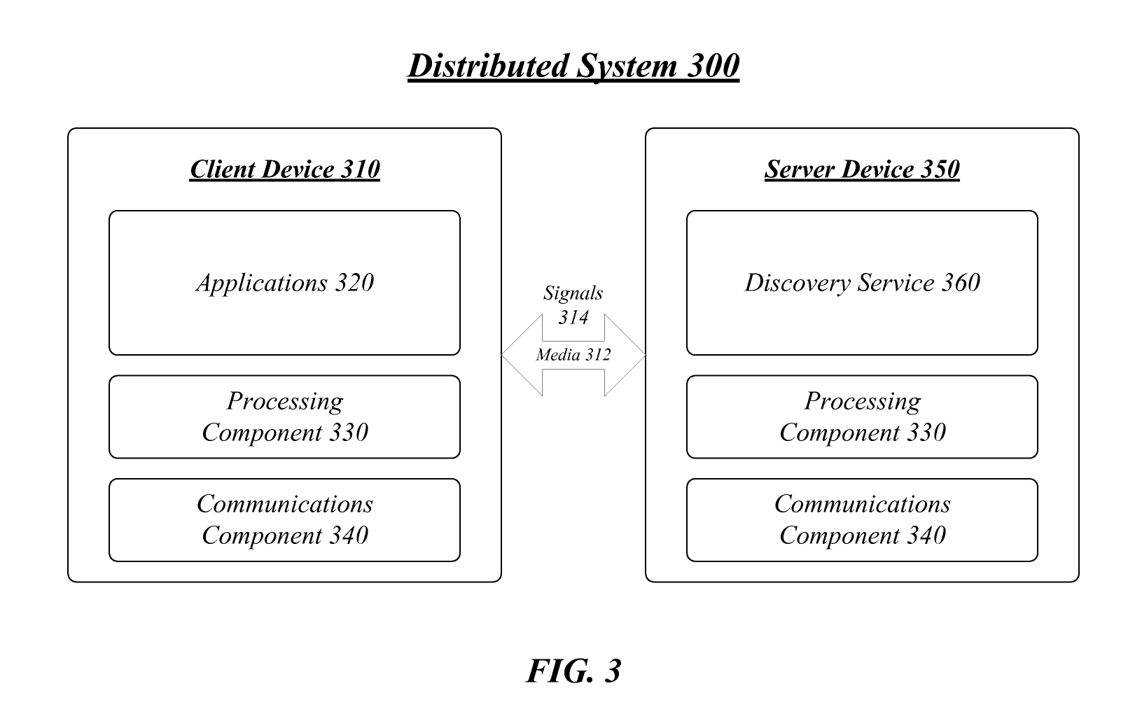

FIG. 3 illustrates a block diagram of a distributed system 300. The distributed system 300 may distribute portions of the structure and/or operations for the system 100 across multiple computing entities. Examples of distributed system 300 may include without limitation a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

The distributed system 300 may comprise a client device 310 and a server device 350. In general, the client device 310 may be the same or similar to the wireless device 120 as described with reference to FIG. 1. For instance, the client device 310 and the server device 350 may each comprise a processing component 330 and a communications component 340 which are the same or similar to the processing circuit 122 and the communications component 144, respectively, as described with reference to FIG. 1. In another example, the devices 310, 350 may communicate over a communications media 312 using communications signals 314 via the communications components 340.

The client device 310 may comprise or employ one or more client programs that operate to perform various methodologies in accordance with the described embodiments. In one embodiment, for example, the client device 310 may implement one or more application(s) 320. Applications 320 may be the same or similar to application 140 and/or connection logic 142.

The server device 350 may comprise or employ one or more server programs that operate to perform various methodologies in accordance with the described embodiments. A server device 350 may be a component of internal network 110 and/or external network 130. In one embodiment, for example, the server device 350 may implement a discovery service 360. Discovery service 360 may be the same or similar to internal discovery service 210 with respect to internal network 110. Discovery service 360 may be the same or similar to external discovery service 230 with respect to external network 130.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

FIG. 4 illustrates one embodiment of a logic flow 400. The logic flow 400 may be representative of some or all of the operations executed by one or more embodiments described herein.

Logic flow 400 may begin when a wireless device needs to connect to a network at block 402. For example, wireless device 120 may have lost connectivity to a first network and may need to connect to a second network. Wireless device 120 may need to connect to a network when application 140 is launched and needs to connect to a network. Wireless device 120 may be moving from a location within internal network 110 to outside of internal network 110.

In the illustrated embodiment shown in FIG. 4, the logic flow 400 may check the access location value at block 404. For example, connection logic 142 may check access location 154.

The logic flow 400 may determine whether the access location value indicates an internal location at block 406. For example, access location 154 may be set to indicate “internal”, “external”, or may have no value, an invalid value or an initial default value.

The logic flow 400 may retrieve an internal probe link from a cache at block 408, when the access location indicates an internal location. For example, connection logic 142 may retrieve an internal probe link 152 from memory unit 150.

The logic flow 400 may attempt to connect to the internal probe link at block 410. For example, connection logic 142 may instruct communications component 144 to connect to the location specified by internal probe link 152.

When the connection to internal probe link 152 is successful, at block 412, the logic flow 400 may redirect to the final location at block 420. For example, connection logic 142 may use internal probe link 152 as a “clue” for which server end point to connect to, and then use that clue to identify the desired server within the internal network that wireless device 120 needs to connect to.

When the connection to internal probe link 152 is not successful, at block 412, the logic flow 400 may perform a discovery process at block 426. An embodiment of a discovery process is described with respect to FIG. 5.

Similarly, if, at block 406, the access value has no value, an invalid value, or a default value, the logic flow 400 may perform the discovery process at block 426.

If the access value at block 406 indicates an external location, the logic flow may retrieve an external probe link from the cache at block 414. For example, connection logic 142 may retrieve an external probe link 152 from memory unit 150.

The logic flow 400 may attempt to connect to the external probe link at block 416. For example, connection logic 142 may instruct communications component 144 to connect to the location specified by external probe link 152.

When the connection to external probe link 152 is successful, at block 418, the logic flow 400 may redirect to the final location at block 420. For example, connection logic 142 may use external probe link 152 as a “clue” for which server end point to connect to, and then use that clue to identify the desired server within the external network that wireless device 120 needs to connect to.

When the connection to external probe link 152 is not successful, at block 418, the logic flow 400 may perform a discovery process at block 426. The embodiments are not limited to this example.

FIG. 5 illustrates one embodiment of a logic flow 500. The logic flow 500 may be representative of some or all of the operations executed by one or more embodiments described herein. Logic flow 500 may be an example of a discovery process as performed in block 426 of logic flow 400.

In the illustrated embodiment shown in FIG. 5, the logic flow 500 may need to connect to a network at block 502. In addition to being performed as part of logic flow 400, the logic flow 500 may also be performed independently, for example, the first time that a wireless device 120, or application 140, needs to connect to a network.

The logic flow 500 may attempt to connect to an internal discovery service at block 504. For example, connection logic 142 may direct communications component 144 to connect to internal discovery service 210.

The logic flow 500 may determine whether the connection attempt with the internal discovery service was successful at block 506. When the connection attempt is successful, the logic flow 500 may redirect to the final location at block 508. A successful attempt indicates that the wireless device is inside the internal network 110, and that the wireless device or application 140 should look inside the internal network 110 for the server(s) it needs. If, for example, application 140 is trying to connect to a service, the final location may be of the form “internal\NameOfService”, where “NameOfService” is the internal network location for the server providing the service.

The logic flow 500 may return an access location value of “internal”, and a link to the final location, at block 510. In the previous example, connection logic 142 may receive “internal” as a value for access location 154, and “internal\NameOfService” as the link to the final location. Connection logic 142 may set access location 154 to have a value indicating an internal location.

The logic flow 500 may cache the final location as an internal probe link at block 512. Connection logic 142 may store the final location link as an internal probe link 152. In an embodiment, the probe link reflects the last successful final location used by any application during the discovery process. In another embodiment, an application-specific probe link 152 may be stored for each application that goes through the discovery process. In this way, the next time that an application 140 needs to connect to its service, if the wireless device is still inside, as determined, for example, by logic flow 400, it can go directly to the final location link without having to go through the discovery process again, and without risking a connection failure from guessing the wrong server location.

Returning to block 506, if the connection attempt to the internal discovery service fails, it is presumed that the wireless device is outside of the internal network 110. The logic flow 500 may therefore connect to an external discovery service at block 514. For example, connection logic 142 may direct communications component 144 to connect to external discovery service 230.

It is assumed that the connection to the external discovery service will succeed at block 514. However, connection failures at this point in logic flow 500 may cause wireless device 120 to start the discovery process again at block 504 (not shown).

The logic flow 500 may redirect to a final location at block 516. Block 516 may be similar to block 508, taking place, however, in external network 130.

The logic flow 500 may return an access location value of “external” and a link to the final location, at block 518. Block 518 may be similar to block 510, however, connection logic 142 may set access location 154 to have a value indicating an external location.

The logic flow 500 may cache the final location as an internal probe link at block 520. Block 520 may be similar to block 512, however, connection logic 142 may store the final location link as an external probe link 152. The embodiments are not limited to this example.

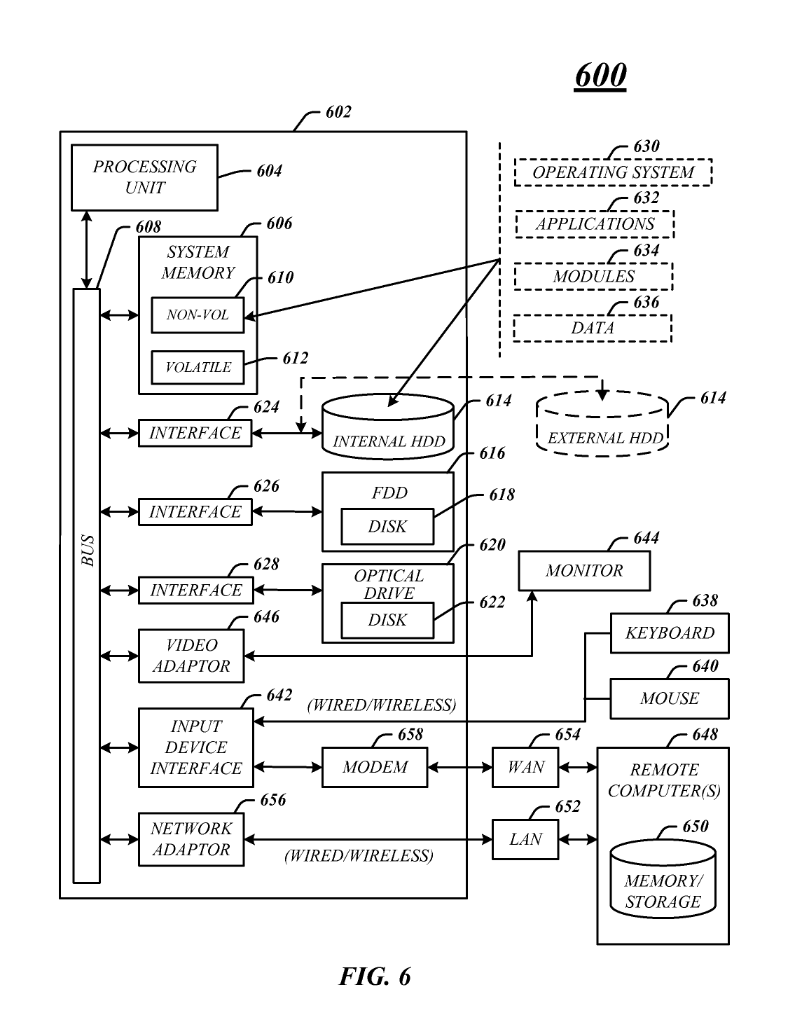

FIG. 6 illustrates an embodiment of an exemplary computing architecture 600 suitable for implementing various embodiments as previously described. In one embodiment, the computing architecture 600 may comprise or be implemented as part of an electronic device. Examples of an electronic device may include those described with reference to FIG. 1, among others. The embodiments are not limited in this context.

As used in this application, the terms “system” and “component” are intended to refer to a computer-related entity, either hardware, a combination of hardware and software, software, or software in execution, examples of which are provided by the exemplary computing architecture 600. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 600 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 600.

As shown in FIG. 6, the computing architecture 600 comprises a processing unit 604, a system memory 606 and a system bus 608. The processing unit 604 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 604.

The system bus 608 provides an interface for system components including, but not limited to, the system memory 606 to the processing unit 604. The system bus 608 can be any of several types of bus structure that may further interconnect to a memory bus (with or without a memory controller), a peripheral bus, and a local bus using any of a variety of commercially available bus architectures. Interface adapters may connect to the system bus 608 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 600 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 606 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 6, the system memory 606 can include non-volatile memory 610 and/or volatile memory 612. A basic input/output system (BIOS) can be stored in the non-volatile memory 610.

The computer 602 may include various types of computer-readable storage media in the form of one or more lower speed memory units, including an internal (or external) hard disk drive (HDD) 614, a magnetic floppy disk drive (FDD) 616 to read from or write to a removable magnetic disk 618, and an optical disk drive 620 to read from or write to a removable optical disk 622 (e.g., a CD-ROM or DVD). The HDD 614, FDD 616 and optical disk drive 620 can be connected to the system bus 608 by a HDD interface 624, an FDD interface 626 and an optical drive interface 628, respectively. The HDD interface 624 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 610, 612, including an operating system 630, one or more application programs 632, other program modules 634, and program data 636. In one embodiment, the one or more application programs 632, other program modules 634, and program data 636 can include, for example, the various applications and/or components of the system 100.

A user can enter commands and information into the computer 602 through one or more wire/wireless input devices, for example, a keyboard 638 and a pointing device, such as a mouse 640. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 604 through an input device interface 642 that is coupled to the system bus 608, but can be connected by other interfaces such as a parallel port, IEEE 1394 serial port, a game port, a USB port, an IR interface, and so forth.

A monitor 644 or other type of display device is also connected to the system bus 608 via an interface, such as a video adaptor 646. The monitor 644 may be internal or external to the computer 602. In addition to the monitor 644, a computer typically includes other peripheral output devices, such as speakers, printers, and so forth.

The computer 602 may operate in a networked environment using logical connections via wire and/or wireless communications to one or more remote computers, such as a remote computer 648. The remote computer 648 can be a workstation, a server computer, a router, a personal computer, portable computer, microprocessor-based entertainment appliance, a peer device or other common network node, and typically includes many or all of the elements described relative to the computer 602, although, for purposes of brevity, only a memory/storage device 650 is illustrated. The logical connections depicted include wire/wireless connectivity to a local area network (LAN) 652 and/or larger networks, for example, a wide area network (WAN) 654. Such LAN and WAN networking environments are commonplace in offices and companies, and facilitate enterprise-wide computer networks, such as intranets, all of which may connect to a global communications network, for example, the Internet.

When used in a LAN networking environment, the computer 602 is connected to the LAN 652 through a wire and/or wireless communication network interface or adaptor 656. The adaptor 656 can facilitate wire and/or wireless communications to the LAN 652, which may also include a wireless access point disposed thereon for communicating with the wireless functionality of the adaptor 656.

When used in a WAN networking environment, the computer 602 can include a modem 658, or is connected to a communications server on the WAN 654, or has other means for establishing communications over the WAN 654, such as by way of the Internet. The modem 658, which can be internal or external and a wire and/or wireless device, connects to the system bus 608 via the input device interface 642. In a networked environment, program modules depicted relative to the computer 602, or portions thereof, can be stored in the remote memory/storage device 650. It will be appreciated that the network connections shown are exemplary and other means of establishing a communications link between the computers can be used.

The computer 602 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

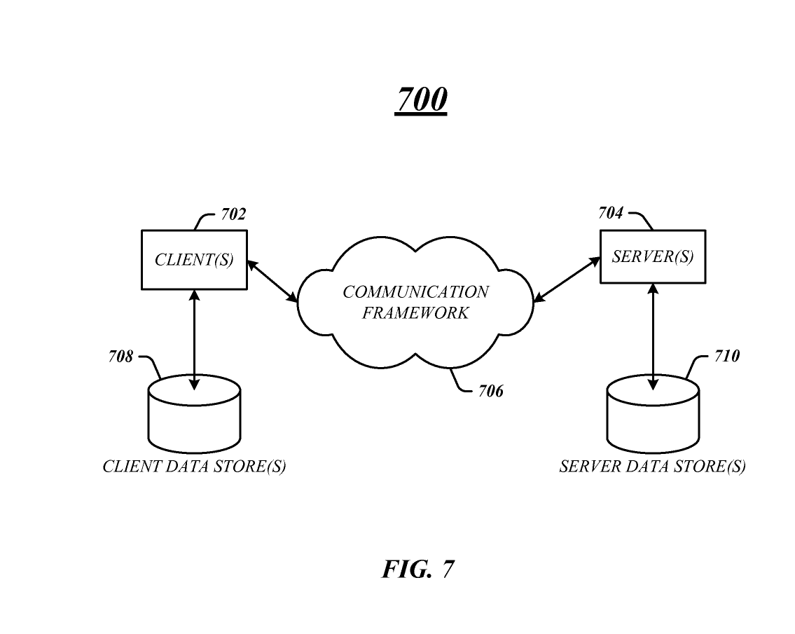

FIG. 7 illustrates a block diagram of an exemplary communications architecture 700 suitable for implementing various embodiments as previously described. The communications architecture 700 includes various common communications elements, such as a transmitter, receiver, transceiver, radio, network interface, baseband processor, antenna, amplifiers, filters, power supplies, and so forth. The embodiments, however, are not limited to implementation by the communications architecture 700.

As shown in FIG. 7, the communications architecture 700 comprises includes one or more clients 702 and servers 704. The clients 702 may implement the client device 910. The servers 704 may implement the server device 950. The clients 702 and the servers 704 are operatively connected to one or more respective client data stores 708 and server data stores 710 that can be employed to store information local to the respective clients 702 and servers 704, such as cookies and/or associated contextual information.

The clients 702 and the servers 704 may communicate information between each other using a communication framework 706. The communications framework 706 may implement any well-known communications techniques and protocols. The communications framework 706 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 706 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.11 a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth needed by clients 702 and the servers 704. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. An apparatus, comprising:
a logic circuit;
a memory unit; and
connection logic operative on the logic circuit to attempt a network connection by:
retrieving a first access location value from the memory unit when attempting a network connection from the apparatus;
retrieving a stored internal probe link from the memory unit when the first access location value is internal;
retrieving a stored external probe link from the memory unit when the first access location value is external;
attempting to connect to a network site referenced by the retrieved probe link; and
connecting to a final location via the network site when the connection attempt to the network site is successful.

2. The apparatus of claim 1, the connection logic operative to, when the connection attempt to the network site is not successful:
attempt to connect to an internal discovery service in an internal network;
connect to a final location within the internal network when the attempt to connect to the internal discovery service succeeds;
receive a second access location attribute value indicating an internal network and the final location link from the internal discovery service; and
store the final location link as an internal probe link in the memory unit.

3. The apparatus of claim 2, the connection logic operative to, when the attempt to connect to the internal discovery service does not succeed:
attempt to connect to an external discovery service in an external network;
connect to a final location within the external network;
receive a third access location attribute value indicating an external network, and the final location, from the external discovery service; and
store the final location as an external probe link.

4. The apparatus of claim 3, wherein the internal network is a private network and the external network is a public network.

5. The apparatus of claim 1, the connection logic operative to attempt a network connection when transitioning from a first network to a second network.

6. The apparatus of claim 1, comprising:
an application stored in the memory unit, wherein executing the application on the logic circuit causes the connection logic to attempt a network connection.

7. The apparatus of claim 6, comprising:
a plurality of applications stored in the memory unit;
a plurality of internal probe links, each internal probe link associated with a separate application; and
a plurality of external probe links, each external probe link associated with a separate application.

8. A computer-implemented method operating on a wireless computing device, comprising:
retrieving a first access location value when attempting a network connection from a wireless device;
retrieving a stored internal probe link when the access location value is internal;
retrieving a stored external probe link when the access location value is external;
attempting to connect to the retrieved probe link; and
connecting to a final location when the connection attempt is successful.

9. The computer-implemented method of claim 8, comprising, when the connection attempt is not successful:
attempting to connect to an internal discovery service in an internal network;
connecting to a final location within the internal network when the attempt to connect to the internal discovery service succeeds;
receiving a second access location attribute value indicating an internal network and the final location link from the internal discovery service; and
storing the final location link as an internal probe link.

10. The computer-implemented method of claim 9, comprising, when the attempt to connect to the internal discovery service does not succeed:
attempting to connect to an external discovery service in an external network;
connecting to a final location within the external network;
receiving a third access location attribute value indicating an external network, and the final location, from the external discovery service; and
storing the final location as an external probe link.

11. The computer-implemented method of claim 10, wherein the internal network is a private network and the external network is a public network.

12. The computer-implemented method of claim 8, comprising:
launching an application that uses a network connection on the wireless device; and
performing the method of claim 8 to establish a network connection for the application.

13. The computer-implemented method of claim 8, comprising:
transitioning from a first network to a second network; and
performing the method of claim 8 to establish a network connection.

14. The computer-implemented method of claim 8, comprising:
storing a plurality of internal probe links, each internal probe link associated with one of a plurality of applications that use a network connection on the wireless device; and
storing a plurality of external probe links, each external probe link associated with one of the plurality of applications.

15. At least one computer-readable storage medium comprising instructions that, when executed, cause a system to:
retrieve a first access location value when attempting a network connection;
retrieve a stored internal probe link when the access location value is internal;
retrieve a stored external probe link when the access location value is external;
attempt to connect to a network site referenced by the retrieved probe link; and
connect to a final location via the network site when the connection attempt to the network site is successful.

16. The computer-readable storage medium of claim 15, comprising instructions that when executed cause the system to, when the connection attempt to the network site is not successful:
attempt to connect to an internal discovery service in an internal network;
receive a second access location attribute value indicating an internal network and an internal link from the internal discovery service, when the attempt to connect to the internal discovery service succeeds;
connect to the internal link within the internal network;
connect to a destination link within the internal network; and
store the destination link as an internal probe link.

17. The computer-readable storage medium of claim 16, comprising instructions that when executed cause the system to, when the attempt to connect to the internal discovery service does not succeed:
attempt to connect to an external discovery service in an external network;
connect to a final location within the external network;
receive a third access location attribute value indicating an external network, and the final location, from the external discovery service; and
store the final location as an external probe link.

18. The computer-readable storage medium of claim 15, comprising instructions that when executed cause the system to: attempt a network connection when transitioning from a first network to a second network.

19. The computer-readable storage medium of claim 15, comprising instructions that when executed cause the system to:
attempt a network connection when an application is launched on the system.

20. The computer-readable storage medium of claim 15, comprising instructions that when executed cause the system to:
store a plurality of internal probe links, each internal probe link associated with one of a plurality of applications that use a network connection in the system; and
store a plurality of external probe links, each external probe link associated with one of the plurality of applications.
